(19) United States
(12) Patent Application Publication
(10) Pub. No.: US 2026/0213222 A1
(43) Pub. Date: Jul. 23, 2026

(54) FUEL CELL ELECTRODE CATALYTIC LAYER AND MEMBRANE ELECTRODE COMPRISING SAME

(71) Applicant: DALIAN INSTITUTE OF CHEMICAL PHYSICS, CHINESE ACADEMY OF SCIENCES, Dalian, Liaoning (CN)

(72) Inventors: Zhigang SHAO, Dalian, Liaoning (CN); Xinyi LIU, Dalian, Liaoning (CN); Wei SONG, Dalian, Liaoning (CN)

(21) Appl. No.: 19/139,022

(22) PCT Filed: Nov. 23, 2023
(86) PCT No.: PCT/CN2023/133495

§ 371 Date: Jun. 13, 2025

(30) Foreign Application Priority Data
Dec. 15, 2022 (CN) 202211617886.5

(51) Int. Cl. H01M 4/86; H01M 4/88; H01M 4/92

(52) U.S. Cl. CPC H01M 4/8668; H01M 4/8896; H01M 4/926

(57) ABSTRACT

A fuel cell electrode catalytic layer and a membrane electrode having the catalyst layer are disclosed. The fuel cell electrode catalytic layer is formed by the mutual bonding and accumulation of resin particles the surfaces of which are coated with catalyst particles, and staggered pore channel structures are arranged between the resin particles, so that the transport capability of a reaction material in the catalytic layer is improved, and a catalyst covering the outer layer of a resin has a relatively high utilization rate. The preparation method for the fuel cell electrode catalytic layer includes the steps of under a heating condition by means of an electrostatic effect, adsorbing and bonding, to the surface of a membrane, powder prepared from the catalyst and the resin, and further curing the powder by means of hot pressing to form a stable catalytic layer.

### TECHNICAL FIELD

The present invention belongs to the technical field of fuel cells, in particular to a fuel cell electrode catalytic layer, a preparation method thereof, and an application therefor.

### BACKGROUND ART

Membrane electrode is a core component of fuel cells, comprising a proton exchange membrane, a catalytic layer, and a gas diffusion layer. Proton exchange membrane is used to transport protons that participate in electrochemical reactions, while the catalytic layer provides a reaction site for electrochemical reactions. The catalyst/proton exchange membrane assembly formed by their combination is a core component of the membrane electrode. Traditional methods for preparing the membrane electrode catalytic layer, such as blade coating method, decal transfer method, and spray coating method, all employ solvents to disperse resin components. These methods involve preparing an ink slurry by mixing resin solutions with catalysts, which is then transferred onto the membrane surface to form a catalytic layer after drying. The advantages of these methods include high dispersity of catalysts and resins components along with operational simplicity. However, on the one hand, resin solution is not easy to form a pore channel structure during drying, which is not conducive to the transport of reactants within the catalytic layer; on the other hand, it tends to form resin-coated catalyst architectures, reducing the catalyst utilization efficiency. Moreover, the use of solvents not only causes membrane swelling but the evaporation of solvent also brings additional energy consumption and environmental pollution, increasing the preparation cost of the catalytic layer.

### SUMMARY

In order to address the technical problems existing in the prior art, the present invention provides a fuel cell electrode catalytic layer and a membrane electrode comprising same. The fuel cell electrode catalytic layer is formed by mutually bonded and accumulated resin particles coated with catalyst particles on surfaces, and there are interlaced pore channel structures between the resin particles, which enhance the transport capability of reactants within the catalytic layer while having high utilization rate of the catalyst covering the surfaces of resins.

To achieve the above objectives, the technical solution adopted by the present invention is as follows:

The present invention provides a fuel cell electrode catalytic layer disposed on both surfaces of the membrane, which is bonded to the surfaces of the membrane through the viscosity of the resin material contained therein.

The fuel cell electrode catalytic layer is formed by mutually bonded and accumulated resin particles coated with catalyst particles on surfaces, and there are interlaced pore channel structures between the resin particles.

A particle size of the resin particles ranges from 0.1 μm to 10 μm.

A particle size of the catalyst particles ranges from 1 nm to 20 nm.

A mass ratio of the catalyst to the resin in the electrode catalytic layer ranges from 20:1 to 1:20.

Due to the preparation process, the particle sizes of the catalyst and resin particles are not a specific value but exhibit a certain particle size distribution: for catalyst particles, the distribution range has an upper limit below 20 nm and a lower limit above 1 nm; and for resin particles, the distribution range has an upper limit below 10 μm and a lower limit above 0.1 μm.

Further, the catalyst is one selected from Pt/C and platinum black.

Further, the resin has a certain viscosity and is one selected from Nafion-H, PVDF and PTFE.

Traditional wet process for preparing membrane electrode catalytic layer involves mixing resin solution with catalyst to form a slurry, which can achieve a high degree of dispersion for both at the same time. In this process, Nafion resin with a long-chain structure is distributed between the catalyst particles, so that the resin tends to coat the catalyst particles when the slurry is dried to form the catalytic layer, reducing the utilization rate of the catalyst and leading to waste of the catalyst. Additionally, the catalytic layer formed after the slurry is dried lacks sufficient pore channel structure, preventing the reactants from being effectively transported within the catalytic layer.

Different from the catalytic layer structure of membrane electrode prepared by traditional wet process in the prior art, in the structure of the fuel cell electrode catalytic layer of the present application, catalyst particles with relatively smaller particle size adhere to the surfaces of resin particles with relatively larger particle size, forming a catalyst-coated resin architectures, enabling the catalyst particles to be bonded by the resins while being exposed as much as possible to realize their catalytic function. The mutually bonded resin particles forms a skeleton framework of the electrode catalytic layer, which provides proton transport channels while retains interlaced pore channel structures formed by accumulated particles, facilitating the transport of reactants.

In a preparation method used to prepare the fuel cell electrode catalytic layer, there is a ratio requirement between the catalyst and the resin: when the catalyst is in excess, the surplus catalyst is prone to lost as it cannot be bonded by the resin; and when the amount of catalyst is insufficient, it will lead to the waste of resin.

The present invention also provides a method for preparing the fuel cell electrode catalytic layer:
(1) Fully grinding and mixing the catalyst particles and resin particles to obtain catalytic layer powder;
(2) Uniformly spreading the catalytic layer powder over a membrane surface to form a catalytic layer; and
(3) Curing and stabilizing the catalytic layer on the membrane surface through hot pressing.

Further, the membrane is one selected from Nafion-H membrane and PBI membrane, which has good proton conductivity and viscosity.

In step (1) of the preparation method, since the electrostatic effect generated by friction, the catalyst and resin acquire opposite charges during mixing, causing them to attract each other and ultimately resulting in the smaller catalyst particles being coated on the surface of the resin particles to form a coated structure.

The uniformity of the electrode catalytic layer is one of the key factors affecting its performance. In step (2) of the preparation method, the uniform distribution of catalysts on the membrane surface facilitates the formation of a uniform catalytic layer in subsequent steps. Methods for spreading the powder include spray coating method, blade coating method, and decal transfer method, etc.

The firming degree of the electrode catalytic layer adhere to the membrane surface is one of the key factors affecting its stability. Therefore, in step (3) of the preparation method, it is necessary to use hot pressing methods to bond the electrode catalytic layer to the membrane by taking advantage of the viscosity of the resin and membrane material during heating, achieving its firm attachment to the membrane surface.

Further, a temperature for the hot pressing ranges from 80° C. to 200° C.

Preferably, the temperature for the hot pressing ranges from 100° C. to 120° C.

Further, a pressure for the hot pressing ranges from 0.1 MPa to 5.0 MPa.

Preferably, the pressure for the hot pressing ranges from 0.5 MPa to 2.0 MPa.

Further, a time for the hot pressing treatment ranges from 1 min to 60 min.

Preferably, the time for the hot pressing ranges from is 5 min to 20 min.

Compared with membrane electrode catalytic layers prepared by traditional wet process, a significant advantage of the fuel cell electrode catalytic layer of the present invention is its ability to largely retain the macroporous structure of the catalytic layer powder particles, which is beneficial for the transport of reactants during actual battery operation. Therefore, the hot pressing process in step (3) of the preparation method is another key point of the entire method, with certain requirements for its parameters:
(1) The resin component in the catalytic layer powder will soften when heated, thereby serving an adhesive function. If the heating temperature is too low, the bonding effect will deteriorate, causing the catalyst particles to be prone to peeling off. Conversely, if the heating temperature is too high, the membrane may deform or even decompose, resulting in decreased performance of the final membrane electrode.
(2) Applying a certain pressure while heating is beneficial for the resin particles in the catalytic layer powder to be fully heated, enhancing the bonding effect. However, excessive pressure can damage the pore structure of the electrode catalytic layer, resulting in decreased performance of the final membrane electrode.
(3) The duration of the hot pressing process should be sufficient to allow the catalytic layer powder particles and the membrane to be fully heated and firmly bonded.

Since membrane electrodes actually used in fuel cells has electrode catalytic layers on both surfaces of the membrane, the following solution can be used to achieve catalytic layers on both surfaces of the membrane when preparing fuel cell membrane electrodes:

First, prepare the required catalytic layer powder according to step (1), then sequentially follow steps (2) and (3) to form a firmly bonded catalytic layer on one surface of the membrane, subsequently repeat steps (2) and (3) in sequence to form a firmly bonded catalytic layer on the other surface of the membrane.

The present invention also provides a fuel cell membrane electrode, including the above-mentioned fuel cell electrode catalytic layer or the fuel cell electrode catalytic layer prepared by the above-mentioned method.

The present invention further provides an application of the fuel cell membrane electrode.

Compared with prior arts, the fuel cell electrode catalytic layer and the preparation method thereof provided by the present invention have the following advantages:
(1) The electrode catalytic layer largely retains the macroporous structure of the powder particles, facilitating the transport of reactants under actual operating conditions;
(2) The coated particle structure formed by catalyst-coated resin in the electrode catalytic layer allows the catalyst particles to be bonded by the resins while being exposed as much as possible to realize their catalytic function, thereby improving the utilization rate of the catalyst.
(3) The preparation method does not use solvents, avoiding additional costs and energy consumption associated with using and evaporating solvents.
(4) The preparation method does not use solvents, making it more environmentally friendly and green compared to traditional wet processes.

### BRIEF DESCRIPTION OF THE DRAWINGS

FIG. 1 is an SEM diagram of raw resin particles.

FIG. 2 is an SEM diagram of raw catalyst particles.

FIG. 3 is an SEM diagram of powder particles formed by mixing resins and catalysts.

FIG. 4 is an SEM diagram of a catalyst/membrane module CCM-1 (side view) containing the fuel cell electrode catalytic layer.

FIG. 5 illustrates a schematic diagram of the structural principle of the fuel cell electrode catalytic layer.

FIG. 6 shows pore size distribution results of the prepared powder particles and the catalyst/membrane module CCM-1 containing the fuel cell electrode catalytic layer.

FIG. 7 shows performance test results (polarization curve) of a single fuel cell equipped with the catalyst/membrane module CCM-1.

### DETAILED DESCRIPTION OF THE EMBODIMENTS

In order to further illustrate the present invention, the following examples are provided based on experimental results and in conjunction with the accompanying drawings, without limiting the scope of the present invention as defined by the claims.

The apparatus given in the examples of the present invention is only one means of implementing the method described in the present invention and does not mean that the method described in the present invention can only be realized through this apparatus.

### Example 1

This example illustrates the preparation of the catalytic layer powder.

Pt/C (with a Pt content of 40 wt. %) catalyst and Nafion-H resin (with a particle size distribution of 0.7-5.0 μm) were weighed at a mass ratio of 1:1, which were thoroughly ground in a mortar for 30 min, followed by fully shaking in a bottle for 10 min to obtain the desired powder with a coated structure.

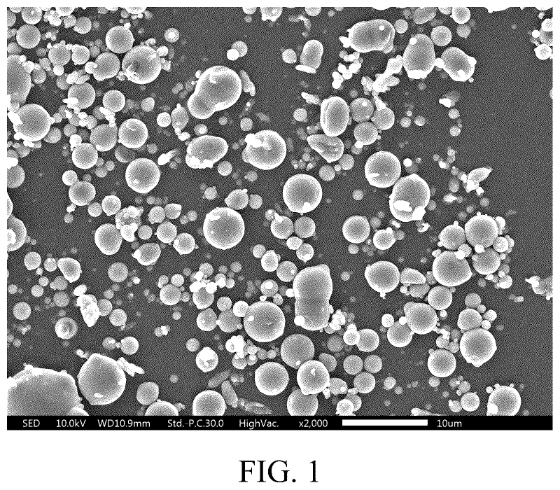

The morphology of raw resin particles was characterized by SEM (Scanning Electron Microscopy), and the result is shown in FIG. 1. It can be seen that the resin particles exhibit spherical morphology with a particle size distribution of 0.7-5.0 μm.

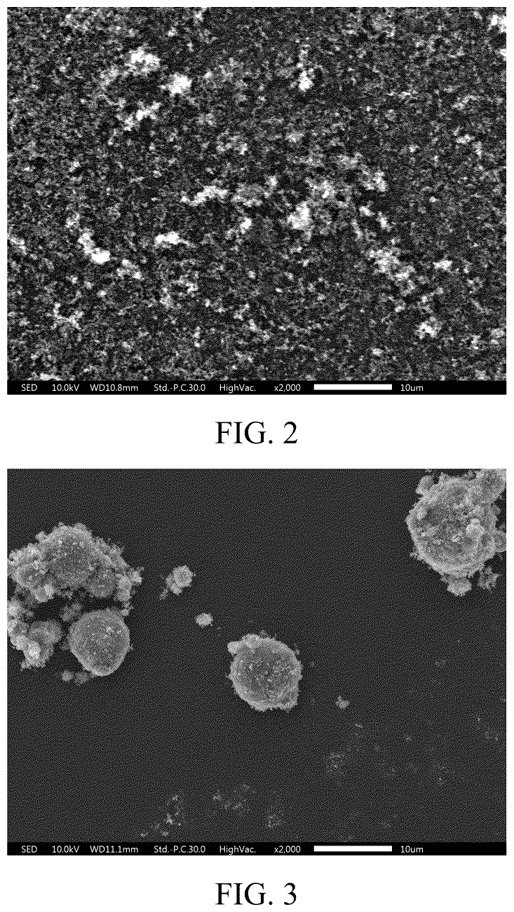

The morphology of raw catalyst particles was characterized by SEM, and the result is shown in FIG. 2. It can be seen that the catalyst particles exhibit nanoscale particle sizes.

The morphology of the prepared powder particles was characterized by SEM, and the result is shown in FIG. 3. It can be seen that the powder particles exhibit a structure that the catalyst particles uniformly coat on the outer surface of the resin particles.

### Example 2

This example illustrates the preparation of the fuel cell electrode catalytic layer.
(1) The catalytic layer powder prepared in Example 1 was loaded into the powder chamber of a dry powder spray gun, and then uniformly sprayed onto one surface of a flat-laid Nafion-H membrane to form an uncured catalytic layer on one side of the membrane;
(2) The above obtained membrane with an uncured catalytic layer on one side was placed on a hot pressing plate for hot pressing treatment to solidify the catalytic layer, with a hot pressing temperature of 120° C., a hot pressing pressure of 1.0 MPa, and a hot pressing time of 10 min;
(3) The catalytic layer powder prepared in Example 1 was uniformly sprayed onto the other surface of the Nafion-H membrane by using the dry powder spray gun to form an uncured catalytic layer on the other side of the membrane; and
(4) The membrane with cured and uncured catalytic layers was placed on the hot pressing plate for hot pressing treatment to solidify the other catalytic layer, with a hot pressing temperature of 120° C., a hot pressing pressure of 1.0 MPa, and a hot pressing time of 10 min, and a prepared catalyst/membrane module was obtained and recorded as CCM-1.

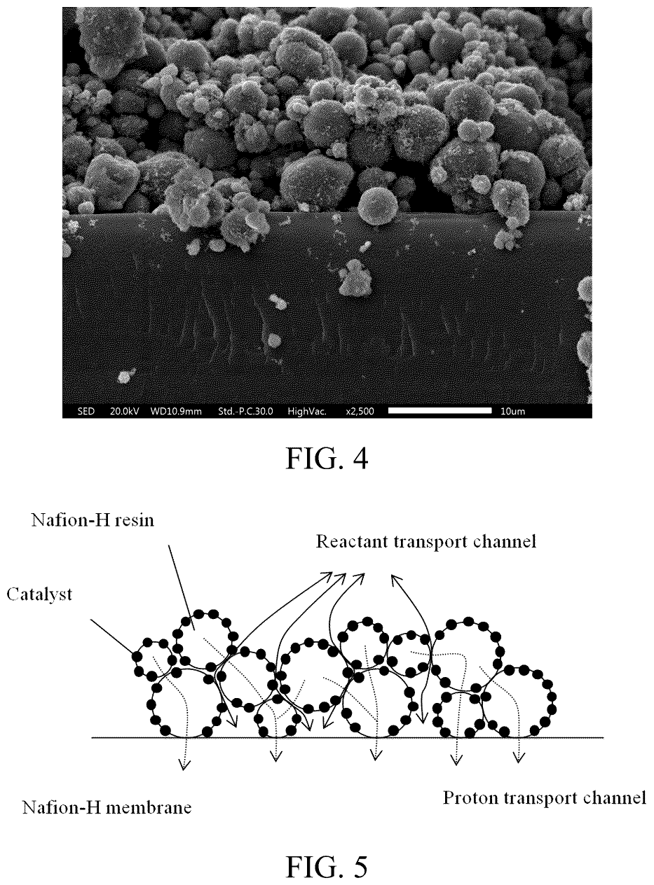

The morphology of the prepared catalyst/membrane module CCM-1 was characterized by SEM, and the result is shown in FIG. 4. It can be seen that the electrode catalytic layer exhibits a skeleton structure formed by mutually bonded resin particles, and provides interlaced pore channel structures formed by particles stacked against each other. The catalyst particles with relatively smaller particle size adhere to the surfaces of the resin particles with relatively larger particle size, enabling the catalyst particles to be bonded by the resins while being exposed as much as possible to realize their catalytic function.

FIG. 5 illustrates a schematic diagram of the structural principle of the fuel cell electrode catalytic layer. The resin particles are mutually bonded to form the skeleton structure of the electrode catalytic layer, forming proton transport channels. At the same time, the interlaced channel structure formed by the powder particles stacked against each other provides transport channels for reactants. The coated particle structure enables the catalyst particles to be bonded by the resins while being exposed as much as possible to realize their catalytic function.

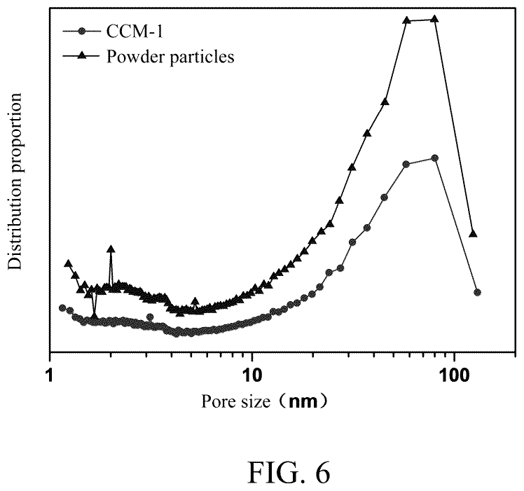

The pore size distributions of the prepared powder particles and catalyst/membrane module CCM-1 were characterized by BET (Brunauer-Emmett-Teller), and the results are shown in FIG. 6. It can be seen that the prepared powder particles and catalyst/membrane module CCM-1 exhibit similar pore size distributions.

### Example 3

The embodiment illustrates a performance test of the catalyst/membrane module containing the fuel cell electrode catalytic layer.

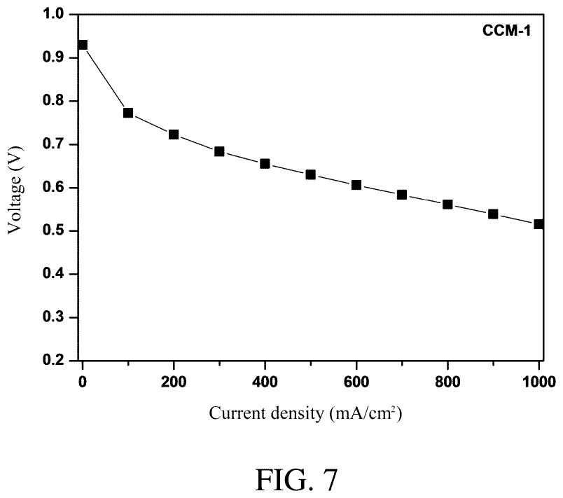

The catalyst/membrane module CCM-1 prepared in Example 2 was cut and hot pressed with a diffusion layer and a frame to form a membrane electrode assembly (MEA). This MEA was installed in a single fuel cell (CCM effective area of 2.0×2.5 cm²), and the single cell was installed on a fuel cell test station for performance test. The performance test conditions were as follows: inlet gas on the positive electrode was air with a pressure of 0.1 MPa and a flow rate of 800 mL/min, inlet gas on the negative electrode was hydrogen with a pressure of 0.1 MPa and a flow rate of 200 mL/min, the cell was maintained at a constant temperature of 80° C., and the temperature of the humidification tanks for both the positive and negative electrodes was 80° C. (100% humidification). At the beginning of the test, the above relevant parameters were set first. After parameter stabilization, the electronic load was turned on, and the output current density was set to 1000 mA/cm² for membrane electrode activation, which lasted for 6 h. After the activation process was completed, the polarization curve was measured, and the results are shown in FIG. 7. It can be seen that the MEA with the electrode catalytic layer prepared according to the preparation method of the present invention has good performance.

1. A fuel cell electrode catalytic layer, wherein
the fuel cell electrode catalytic layer is formed by mutually bonded and accumulated resin particles coated with catalyst particles on surfaces, and there are interlaced pore channel structures between the resin particles;
a particle size of the resin particles ranges from 0.1 μm to 10 μm;
a particle size of the catalyst particles ranges from 1 nm to 20 nm; and
a mass ratio of the catalyst to the resin in the electrode catalytic layer ranges from 20:1 to 1:20.

2. The fuel cell electrode catalytic layer according to claim 1, wherein
the catalyst is one selected from Pt/C and platinum black; and
the resin is one selected from Nafion-H, PVDF and PTFE.

3. A method for preparing the fuel cell electrode catalytic layer according to claim 1, comprising:
(1) fully grinding and mixing the catalyst particles and resin particles to obtain catalytic layer powder;
(2) uniformly spreading the catalytic layer powder over a membrane surface to form a catalytic layer; and
(3) curing and stabilizing the catalytic layer on the membrane surface through hot pressing.

4. The method for preparing the fuel cell electrode catalytic layer according to claim 3, wherein
the membrane is one selected from Nafion-H membrane and PBI membrane.

5. The method for preparing the fuel cell electrode catalytic layer according to claim 3, wherein
a temperature for the hot pressing ranges from 80° C. to 200° C.;
a pressure for the hot pressing ranges from 0.1 MPa to 5.0 MPa; and
a time for the hot pressing ranges from 1 min to 60 min.

6. A fuel cell membrane electrode, comprising the fuel cell electrode catalytic layer according to claim 1.

7. An application of the fuel cell membrane electrode according to claim 6.

8. A fuel cell membrane electrode, comprising the fuel cell electrode catalytic layer prepared by the method according to claim 3.
